(19) United States
(12) Patent Application Publication
(10) Pub. No.: US 2005/0236099 A1
(43) Pub. Date: Oct. 27, 2005

(54) Method for attaching a planar textile structure to a retainer, and apparatus for carrying out said method

(76) Inventor: Rudi Roller, (US)

Correspondence Address: BERENATO, WHITE & STAVISH, LLC, 6550 ROCK SPRING DRIVE, SUITE 240, BETHESDA, MD, 20817, US

(21) Appl. No.: 11/110,894

(22) Filed: Apr. 21, 2005

(30) Foreign Application Priority Data
Apr. 21, 2004 (DE) 20 2004 006 274
Apr. 24, 2004 (DE) 20 2004 006 525

(51) Int. Cl. B32B 31/24

(52) U.S. Cl. 156/272.8; 156/275.5; 156/380.9

(57) ABSTRACT

A method and apparatus for attaching a planar textile structure (43) to a retainer (42) includes a planar structure (43) joined to retainer (42) by means of an adhesive curable by UV radiation. An adhesive deposit is applied onto the retainer (42) and is then cured by means of at least one UV illuminator device (1). The UV radiation of the UV illuminator device (1) is concentrated onto the adhesive deposit and moved along the adhesive deposit.

### CROSS-REFERENCE TO RELATED APPLICATIONS AND CLAIM TO PRIORITY

This application is based upon utility model application number 20 2004 006 274, filed Apr. 21, 2004, and utility model application number 20 2004 006 525, filed Apr. 21, 2005, both in the Federal Republic of Germany, the disclosures of which are incorporated herein by reference and to which priority is claimed.

### FIELD OF THE INVENTION

The invention concerns a method for attaching a planar textile structure to a retainer, in which the planar structure is joined to the retainer by means of an adhesive curable by UV radiation, by the fact that an adhesive deposit is applied onto the retainer and is then cured by means of at least one UV illuminator device. The invention further concerns an apparatus for attaching a planar textile structure to a retainer by means of an adhesive curable by UV radiation, having at least one UV illuminator device that is suspended on a guidance device.

### BACKGROUND OF THE INVENTION

Several steps are necessary for production of a screen printing forme. Firstly a screen printing fabric is stretched over a screen printing frame. The screen printing frame has for that purpose tensioning devices such as those known, for example, from DE 195 43 235 A1, EP 0 925 195 B1, and DE 196 46 987 A1. After stretching, the screen printing fabric is adhesively bonded to the screen printing frame. For this, an adhesive is applied onto the screen printing fabric in the region of the screen printing frame, and penetrates through the screen printing fabric to the screen printing frame. After the adhesive has cured, the screen printing fabric is coated with a water-soluble, light-sensitive emulsion (also called stencil material). The coating is then exposed using a camera-ready original corresponding to the printed image. This causes the exposed regions to cure. The unexposed regions remain water-soluble, and are then rinsed away. This creates the screen printing stencil with the screen printing fabric as stencil carrier.

It is known in the existing art to use not only conventional adhesives but also adhesives curable by UV radiation (see Ullmann's Encyclopedia of Industrial Chemistry, 2003, 6th ed., Vol. 1, pp. 411-412) to attach the screen printing fabric to the screen printing frame. After application, the adhesive is exposed using flash UV light, and cures as a result. The advantages of a UV-curable adhesive are that no solvent emissions occur, and that the adhesive is solvent-resistant even without being overcoated.

The apparatus for carrying out this method comprises a hood, covering the stretching frame, inside which is arranged a UV exposure bar that extends over the width of the stretching frame and radiates over that width. It is displaceable parallel to the screen printing frame transversely to its longitudinal axis. In order to cure the adhesive, the UV illuminator device sweeps over and exposes the entire surface of the screen printing fabric.

A disadvantage of this type of adhesive curing is that the screen printing fabric is heated in strip fashion and over its entire width, so that distortion of the screen printing fabric occurs with the result that it becomes irregular.

### SUMMARY OF THE INVENTION

It is thus the object of the invention to make available a method of the kind cited initially with which distortion of planar textile structures, such as screen printing fabrics or the like, and thus the formation of irregularities, is prevented. A second object is that of designing an apparatus with which the method can be practiced.

The first part of the object is achieved, according to the present invention, by the fact that the UV radiation of the UV illuminator device is concentrated onto the adhesive deposit and moved along the adhesive deposit. The basic idea of the invention is thus to allow the UV radiation to act only where it is in fact needed, namely in the region of the adhesive deposit, and then to move the UV radiation along the adhesive deposit. Heating of the planar textile structure is thereby limited to that region. The other regions remain at ambient temperature. The result is to prevent distortion of the planar textile structure and the creation of irregularities.

According to the teaching of the invention, the concentration of the UV rays need not be limited to the adhesive deposit, but can also encompass adjacent regions in order also to cure any adhesive that has flowed into them. What is essential is that the screen printing fabric is otherwise very largely unaffected by the impingement of UV radiation.

The method according to the present invention is not only suitable for the attachment of screen printing fabrics to screen printing frames, but can be applied universally to the attachment of planar textile structures to retainers. One alternative area of application, for example, is the attachment of a filter cloth to a filter holder, for example in the form of a filter frame.

A single individual beam may suffice for curing of the adhesive deposit. The possibility also exists, however, of assembling the UV radiation of the UV illuminator device from several individual beams. If the individual beams are focused onto a common center point, this results in an increase in energy density and thus in accelerated curing of the adhesive. The possibility also exists, however, of causing the individual beams to strike the adhesive deposit alongside one another or in partially overlapping fashion, so that a larger area of the adhesive deposit is simultaneously impinged upon by UV radiation.

The UV illuminator device should usefully move parallel to the planar structure, so that upon displacement of the UV illuminator device, its spacing from the screen printing frame remains substantially the same. To achieve the highest possible energy density, the UV radiation should be directed substantially perpendicularly onto the adhesive deposit.

Suitable adhesives are acrylic esters or combinations of acrylates with aliphatic or aromatic epoxy resins, urethanes, polyesters, or polyethers, and combinations of hydroxyl-group-containing polymers with cycloaliphatic epoxides. The curing mechanism can be both radical and cationic in nature. The UV radiation should be within a wavelength range from 250 to 445 nm.

In a further embodiment of the invention, provision is made for the adhesive to be applied by means of an adhesive application unit that is displaced along the retainer, before it is cured by means of the UV illuminator device. Adhesive application units of this kind are known in connection with the adhesive bonding of screen printing fabrics. For this purpose, an adhesive nozzle is mounted on an application carriage that is displaceable on a carrier in the X direction, the carrier itself being guided in the Y direction. As a result of the combination according to the present invention, the application of adhesive and curing thereof can be accomplished in two immediately successive steps, in highly automated fashion.

The second part of the object is achieved, according to the present invention, by way of an apparatus in which the UV illuminator device comprises at least one UV point emitter. A “point emitter” in this context is to be understood as a UV illuminator in which the UV radiation is concentrated onto the adhesive deposit that is provided in the manner intended, i.e. the irradiated area is not substantially larger than the adhesive deposit. Because of this delimiting of the UV radiation, the planar textile structure, for example the screen printing fabric, is impinged upon by UV radiation at those locations where attachment using the adhesive is to occur. Distortion of the planar structure is thereby prevented.

The guidance device of the apparatus according to the present invention should be embodied in such a way that the UV illuminator device is movable in an X-Y motion plane, the X and Y motion directions preferably being perpendicular to one another. This can be brought about, for example, by the fact that the guidance device has a carrier which is movable in an X direction and on which is mounted an illuminator carriage, carrying the UV illuminator device, that is guided on the carrier shiftably in the Y direction. The carrier is usefully embodied as a gantry having lateral gantry columns that are mounted on parallel guide rails.

The UV illuminator device can comprise several UV point emitters that are suspended in a common illuminator retainer, in order either to increase the energy density or to impinge upon a larger contiguous area with UV radiation. The UV point emitters should be grouped next to one another in a plane parallel to the motion plane, and suspended pivotably about axes that are each parallel to the motion plane. The UV point emitters should preferably be arranged on a circle, and the pivot axes should extend along tangents to that circle or parallel thereto. As a result, the area to be irradiated can be adjusted in accordance with particular requirements. It is useful if the pivot axes are connected to an adjustment device with which they are adjustable together in terms of their inclination, in such a way that they each assume the same angle with respect to the perpendicular onto the motion plane.

Particularly preferred is an apparatus in which the UV illuminator device is connected to at least one adhesive application device, so that the adhesive can be both applied and then cured using the apparatus. If the UV illuminator device comprises several UV point emitters, the adhesive application device is usefully arranged between the UV point emitters.

The apparatus according to the present invention can be embodied so that it is combinable with the support device for the retainer onto which the planar textile structure is to be attached. A support device of this kind can also, however, be part of that apparatus, the UV illuminator device usefully being movable equidistantly relative to the support device.

The UV illuminator device is advantageously moved using electric-motor drives. These drives should be controllable via a control device, so that the UV irradiation operation is accomplished largely, if not entirely, automatically.

Lamps known in the existing art, such as mercury vapor lamps but also xenon and hydrogen lamps, can be used as UV point emitters. It is particularly favorable to use as the radiation source light-emitting diodes that emit UV light, since they radiate relatively cold and moreover invisible light in the 395-nm wavelength region.

It is understood that not only can the apparatus according to the present invention comprise only one UV illuminator device having one or more UV point emitters, but several such illuminator devices can also be provided, so that curing of the adhesive—and, if several adhesive application devices are present, application thereof—can be performed quickly.

### BRIEF DESCRIPTION OF THE DRAWINGS

The invention is elucidated in more detail, with reference to an exemplifying embodiment, in the drawings, in which:

FIG. 1 is a vertical section through the apparatus according to the present invention, without UV illuminators;

FIG. 2 is a view of the UV illuminator device from below, without UV illuminators;

FIG. 3 is a plan view of a screen printing frame with a stretched-on screen printing fabric, with the focus regions of the UV illuminators;

FIG. 4 is a vertical section through the apparatus according to the present invention, with UV illuminators; and

FIG. 5 is a side view of the apparatus according to the present invention.

### DETAILED DESCRIPTION OF THE PREFERRED EMBODIMENT(S)

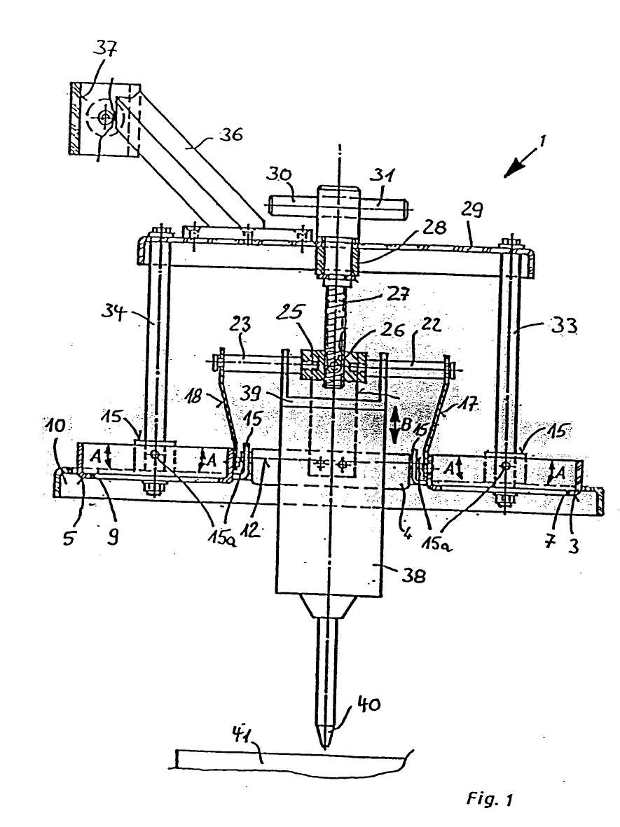

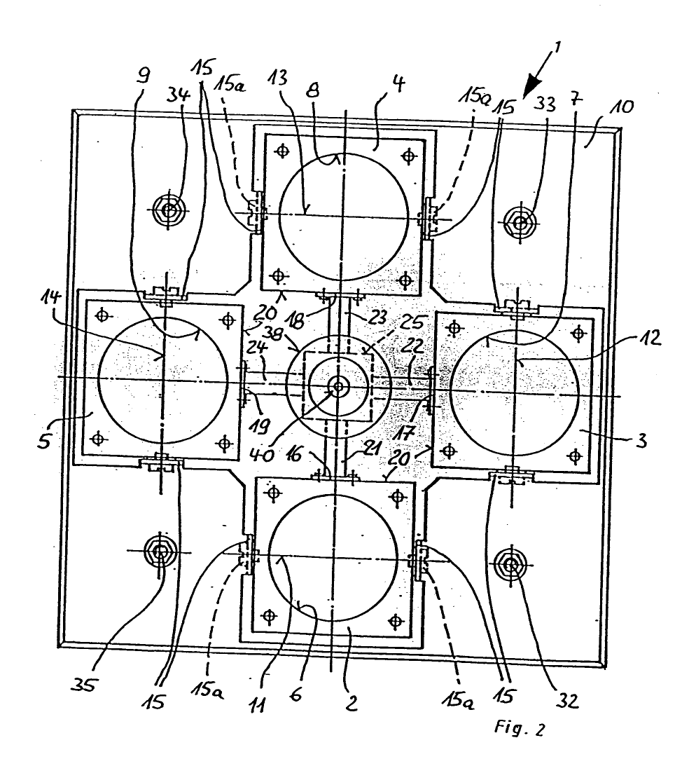

UV illuminator device 1 depicted in FIGS. 1 and 2 comprises four individual holders 2, 3, 4, 5, which are arranged at 90° angles from one another. They have circular openings 6, 7, 8, 9 in which UV illuminators can be installed.

Individual holders 2, 3, 4, 5 are mounted in a frame 10 pivotably, in accordance with double arrows A (FIG. 1), about horizontal pivot axes 11, 12, 13, 14. Pivot axes 11, 12, 13, 14, extend tangentially to a circle that extends through the center points of openings 7, 8, 9 of individual holders 2, 3, 4, 5. Pivot axes 11, 12, 13, 14 are formed on frame 10 by bearing plates 15 and bearing screws 15a.

Individual holders 2, 3, 4, 5 are connected, via brackets 16, 17, 18, 19 that engage onto inner sides 20 of individual holders 2, 3, 4, 5, to horizontal crosspieces 21, 22, 23, 24 that converge at the center at an adjustment nut 25. Adjustment nut 25 comprises a vertical threaded hole 26 into which a vertically extending positioning spindle 27 fits from above. Positioning spindle 27 is mounted rotatably in a bushing 28 that is immobilized in a plate 29. Positioning spindle 27 is guided axially immovably in bushing 28.

Positioning spindle 27 comprises grip elements 30, 31 with which positioning spindle 27 can be rotated manually. Rotation of positioning spindle 27 causes adjustment nut 25 to be moved up or down in the directions of double arrow B, thereby carrying crosspieces 21, 22, 23, 24 along. This vertical adjustment is transferred via brackets 16, 17, 18, 19 to individual holders 2, 3, 4, and 5, with the result that individual holders 2, 3, 4, 5 are each pivoted by the same angular amount about their pivot axes 11, 12, 13, 14.

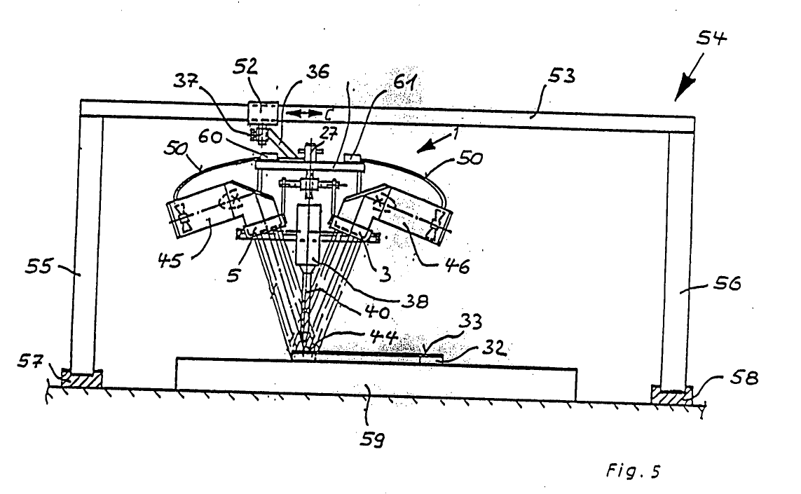

Plate 29 is immovably joined to frame 10 via spacer bolts 32, 33, 34, 35. Attached to plate 29 is a tubular receiving arm 36 that is connected to a guidance element 37 with which UV illuminator device 1 can be joined to a guidance device apparent from FIG. 5.

An adhesive application device 38 is attached to crosspieces 21, 22 via a retainer 39. Adhesive application device 38 has on the underside an application nozzle 40 through which adhesive can be applied from adhesive application device 38 onto a workpiece 41. The adhesive is UV-curable, so that after adhesive application it can be cured by means of UV illuminators inserted into openings 6, 7, 8, 9.

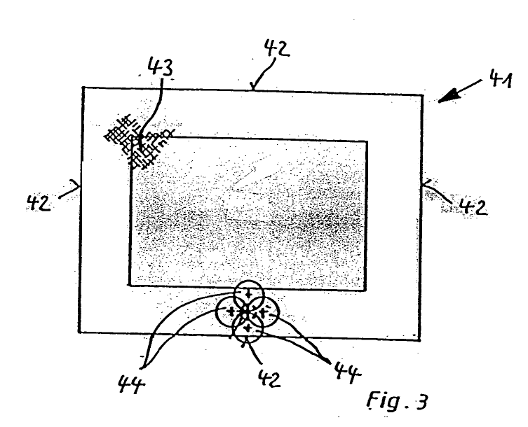

As FIG. 3 shows, workpiece 41 comprises a screen printing frame 42 and a screen printing fabric 43 stretched over screen printing frame 42. Screen printing fabric 43 is attached to the surface of screen printing frame 42 by means of a UV-curable adhesive. In a first working step the adhesive had previously been applied substantially in strips in the region of screen printing frame 42, by means of adhesive application device 38, onto screen printing fabric 43 stretched over screen printing frame 42. The adhesive penetrates by capillary action through screen printing fabric 43 to screen printing frame 42. In a second working step, the adhesive is cured by means of UV radiation from the four UV illuminators. The UV illuminators generate on screen printing fabric 43 point-like radiation areas 44 that overlap one another and extend laterally slightly beyond screen printing frame 42. Because of the oblique irradiation, adhesive that has run down the side of screen printing frame 42 is also cured.

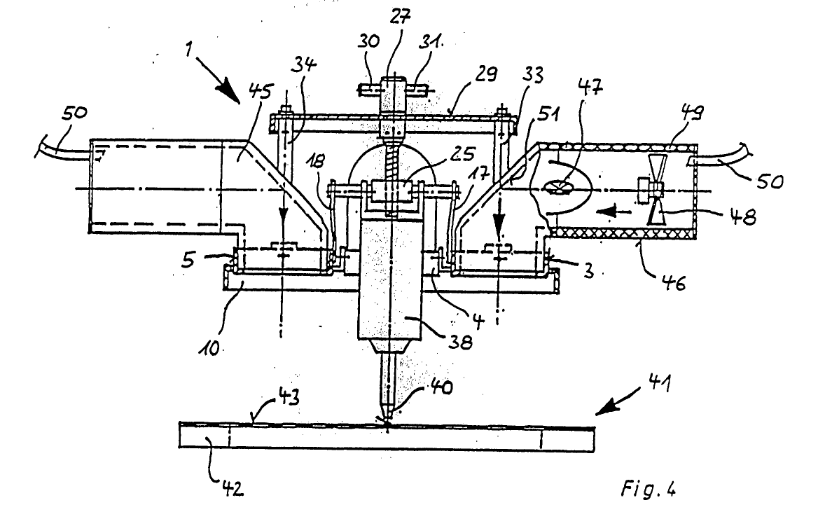

FIG. 4 shows UV illuminator device 1 with UV illuminators 45, 46 inserted into individual holders 2, 3, 4 (the other two UV illuminators are not depicted). As is evident for example from UV illuminator 46, UV illuminators 45, 46 comprise a UV lamp 47 and an axial cooling fan 48, which are arranged inside an illuminator housing 49. A cable 50 serves to supply power. UV illuminator 46 comprises a mirror 51 that deflects the UV light generated by UV lamp 47 from the horizontal to the vertical, and thereby directs it onto workpiece 41.

It is evident from FIG. 5 that UV illuminator device 1 is suspended via receiving arm 36 and guidance element 37 from a slide 52 that is guided on a crossbeam 53 in horizontally shiftable fashion in the directions of arrow C (X direction). Crossbeam 53 is part of a gantry 54. The ends of crossbeam 53 rest on gantry supports 55, 56 that are guided at the bottom in rails 57, 58. The rails extend perpendicularly to the drawing plane, so that gantry 54 is movable in that (Y) direction. Because gantry 54 is movable in the one direction and slide 52 in the other direction extending perpendicular thereto, UV illuminator device 1 can be moved to any point on workpiece 41. Workpiece 41 itself rests on a support table 59. The clamping devices for stretching screen printing fabric 43 are not depicted further.

UV illuminators 45, 46, which in contrast to the depiction of FIG. 4 are arranged at an inclination, generate on screen printing frame 42 radiation areas 44 that are substantially concentrated or focused onto the frame surface of screen printing frame 42. In the region of the opening of screen printing frame 42, screen printing fabric 43 is impinged upon not at all, or only to a small extent in the region of the frame surface, with UV radiation.

As is also evident from FIG. 5, cables 50 proceeding from UV illuminators 45, 46 extend to electronic components 60, 61 that are arranged on plate 29.

1. A method for attaching a planar textile structure (43) to a retainer (42), in which the planar structure (43) is joined to the retainer (42) by means of an adhesive curable by UV radiation, by the fact that an adhesive deposit is applied onto the retainer (42) and is then cured by means of at least one UV illuminator device (1),
wherein the UV radiation of the UV illuminator device (1) is concentrated onto the adhesive deposit and moved along the adhesive deposit.

2. The method as defined in claim 1, wherein a screen printing fabric (43) is used as the planar structure, and is adhesively bonded to a screen printing frame (42) as the retainer.

3. The method as defined in claim 1, wherein a filter cloth is used as the planar structure, and is adhesively bonded to a filter retainer.

4. The method as defined in claim 1, wherein the UV radiation is assembled from several individual beams.

5. The method as defined in claim 4, wherein the individual beams are focused onto a common center point.

6. The method as defined in claim 1, wherein the individual beams strike the adhesive deposit alongside one another or in overlapping fashion.

7. The method as defined in claim 1, wherein the UV illuminator device (1) is moved parallel to the planar structure (43).

8. The method as defined in claim 1, wherein the UV radiation is directed substantially perpendicularly onto the adhesive deposit.

9. The method as defined in claim 1, wherein acrylic esters or combinations of acrylates with aliphatic or aromatic epoxy resins, urethanes, polyethers, and combinations of hydroxyl-group-containing polymers with cycloaliphatic epoxides, are used as the adhesive.

10. The method as defined in claim 1, wherein radically or cationically curing UV systems are used as the adhesive.

11. The method as defined in claim 1, wherein the UV radiation is within a wavelength range from 250 to 445 nm.

12. The method as defined in claim 1, wherein the adhesive is applied by means of at least one adhesive application device (38) that is displaced along the retainer (42), before it is cured by means of the UV illuminator device (1).

13. An apparatus for attaching a planar textile structure (43) to a retainer (42) by means of an adhesive curable by UV radiation, having at least one UV illuminator device (1) that is suspended on a guidance device (52, 54) by means of which the UV illuminator device (1) is displaceable,
wherein the UV illuminator device (1) comprises at least one UV point emitter (45, 46).

14. The apparatus as defined in claim 13, wherein the guidance device (52, 54) is embodied in such a way that the UV illuminator device (1) is movable in an X-Y motion plane.

15. The apparatus as defined in claim 14, wherein the X and Y directions are at right angles to one another.

16. The apparatus as defined in claim 15, wherein the guidance device comprises a carrier (53) which is movable in an X direction and on which is mounted an illuminator carriage (52), carrying the UV illuminator device (1), that is guided on the carrier (53) shiftably in the Y direction.

17. The apparatus as defined in claim 16, wherein the carrier is embodied as a gantry (54) having lateral gantry columns (55, 56) that are mounted on parallel guide rails (57, 58).

18. The apparatus as defined in claim 13, wherein the UV illuminator device (1) comprises several UV point emitters (45, 46) that are suspended in a common illuminator retainer.

19. The apparatus as defined in claim 18, wherein the UV point emitters (45, 46) are grouped next to one another in a plane parallel to the motion plane.

20. The apparatus as defined in claim 19, wherein the UV point emitters (45, 46) are each suspended pivotably about at least one pivot axis (11, 12, 13, 14) that is parallel to the motion plane.

21. The apparatus as defined in claim 20, wherein the UV point emitters (45, 46) are arranged on a circle, and the pivot axes (11, 12, 13, 14) extend along tangents to that circle or parallel thereto.

22. The apparatus as defined in claim 21, wherein the pivot axes (11, 12, 13, 14) are connected to an adjustment device (27) with which they are adjustable together in terms of their inclination, in such a way that they each assume the same angle with respect to the perpendicular onto the motion plane.

23. The apparatus as defined in claim 13, wherein the UV illuminator device (1) is connected to an adhesive application device (38).

24. The apparatus as defined in claim 23, wherein the UV illuminator device (1) comprises several UV point emitters (45, 46) and the adhesive application device (38) is arranged between the UV point emitters (45, 46).

25. The apparatus as defined in any of claim 13, wherein the guidance device (52, 54) is arranged above a support device (59) for the slide (52) in such a way that the UV illuminator device (1) is movable relative to the support device (59).

26. The apparatus as defined in claim 25, wherein the UV illuminator device (1) is movable equidistantly with respect to the support device (59).

27. The apparatus as defined in any of claim 13, wherein the UV illuminator device (1) is moved using drives that are controllable via a control device.

28. The apparatus as defined in claim 13, wherein the UV point emitter(s) respectively comprise(s) as the radiation source at least one light-emitting diode that emits UV light.
